(19) United States
(12) Patent Application Publication
(10) Pub. No.: US 2025/0073619 A1
(43) Pub. Date: Mar. 6, 2025

(54) DEVICE FOR PROVIDING AND TREATING A LIQUID, FILTER BAG, METHOD FOR PRODUCING A FILTER BAG AND USE

(71) Applicant: Hilti Aktiengesellschaft, Schaan (LI)

(72) Inventor: Goran GOLUBOVIC, Buchloe (DE)

(21) Appl. No.: 18/813,139

(22) Filed: Aug. 23, 2024

(30) Foreign Application Priority Data
Sep. 5, 2023 (EP) 23195370.4

(51) Int. Cl. B01D 29/11; B01D 37/03; C02F 1/00; C02F 1/56

(52) U.S. Cl. CPC B01D 29/117; B01D 29/111; B01D 37/03; C02F 1/001; C02F 1/56

(57) ABSTRACT

A device for providing and treating a liquid, wherein the liquid in an interior of the device can be purified by a filter bag and can be taken up by the filter bag. An inner side of the filter bag is at least partially coated with a flocculant. In further aspects, the invention relates to a method for producing a filter bag for such a device and to a filter bag and to the use of such a filter bag in a device for providing and treating a liquid. The capacity of a filter bag can be utilized considerably better and exchange intervals can be extended significantly.

This claims priority to European Patent Application EP 23195370.4 filed on Sep. 5, 2023 which is hereby incorporated by reference herein.

The present invention relates to a device for providing and treating a liquid, wherein the liquid in an interior of the device can be purified by means of a filter bag and can be taken up by the filter bag. In further aspects, the invention relates to a method for producing a filter bag for such a device and to a filter bag and to the use of such a filter bag in a device for providing and treating a liquid.

### BACKGROUND OF THE INVENTION

In the construction industry, devices for providing and treating liquids are known, which are in particular also referred to as water management systems (WMS). Such apparatuses are configured to take up liquids arising on construction sites, purify them and dispense them again in purified form. Such devices are thus used to keep a liquid circuit on a construction site in operation and to ensure that rinsing or cooling water—for example for carrying out core drilling work, which requires both—is always available. In this respect, such devices for providing and treating liquids in particular enable core drilling work to be carried out on those construction sites where water is not freely available and which possibly cannot easily be provided with water lines.

In connection with the present invention, “liquids” refer in particular to those mixtures comprising used rinsing or cooling water and drill cuttings and/or dust. In the context of the invention, the liquids composed in this way can preferably also be referred to as “drilling liquid” or “drilling slurry”. From the consistency and particle composition, the drill cuttings and the dust can have an extremely inhomogeneous appearance. In particular, the diameters of the drill cutting particles and dust particles can deviate from one another by multiple orders of magnitude, i.e. powers of ten. In addition to the macroscopic drill cutting particles and dust particles, the drilling liquid can also contain traces of various chemicals, such as cleaning agents or coolants, which are intended to improve the function of the rinsing or cooling liquid.

### SUMMARY OF THE INVENTION

Hitherto, filter bags have been used in such devices for providing and treating liquids in order to take up and purify the drilling liquid. The device for providing and treating a liquid can be connected to a power tool and suck in the drill cutting particles and/or dust particles produced when working with the power tool. As a result, these drill cutting particles and/or dust particles pass into the filter bag in the interior of the device for providing and treating a liquid. It has been shown that in particular the smaller drill cutting particles and/or dust particles, i.e. the drill cutting particles and/or dust particles having a comparatively small diameter, remain suspended in an upper region of the filter bag or the drilling liquid within the filter bag. However, it is precisely these comparatively small drill cutting particles and/or dust particles that close the still open, i.e. passable pores in the upper region of the filter bag of the device for providing and treating a liquid, as a result of which the capacity of the filter bag can undesirably no longer be fully utilized, even though the filter bag is not yet completely filled. As a result, the filter bag has to be changed more frequently than actually necessary and the time span between two filter change operations (filter change interval) becomes shorter. These shortened filter change intervals undesirably reduce the work efficiency and the work progress and are complex and labour-intensive. Furthermore, new filter bags for the device for providing and treating a liquid have to be provided regularly.

It is an object of the present invention to overcome the above-described defects and disadvantages of the prior art and to provide a device for providing and treating a liquid, with which an inserted filter bag can be utilized better and for a longer period of time. The invention additionally concerns the specification of an improved filter bag, a production method therefor and the use in a device for providing and treating a liquid.

The present invention provides a device for providing and treating a liquid, wherein the liquid in an interior of the device can be purified by means of a filter bag and can be taken up by the filter bag. The device is characterized in that an inner side of the filter bag is at least partially coated with a flocculant. Such a device for providing and treating a liquid can be used, for example, on a construction site and be operated together with a power tool. When working with a power tool, various particles can be generated, for example during drilling, chiselling, hammering or grinding, without being restricted thereto. Such particles, which can be referred to as “drill cutting particles and/or dust particles” in the context of the invention, can comprise rock, masonry, concrete, wood, metal or steel, without being restricted thereto. The drill cutting particles and/or dust particles can in particular have very different diameters. For example, the diameters of the drill cutting particles and/or dust particles may lie in the range from a few micrometres (10⁻⁶ m) to a few centimetres (10⁻² m).

It has been shown that especially those drill cutting particles and/or dust particles having a comparatively small diameter block the filter pores an upper region of the filter bags used in devices for providing and treating liquids. This clogging of the upper pores of the filter bags disadvantageously has the effect that the devices for providing and treating liquids very quickly indicate that the inserted filter bag should be exchanged. This can sometimes even occur when the currently inserted filter bag is not yet completely filled and could still continue to be used. In order to remedy this defect, the inventor has identified that a flocculant can be used in order to clump together especially those drill cutting particles and/or dust particles having a comparatively small diameter, such that they form larger particles and sink more quickly than hitherto to a lower region of the filter bag where they no longer have a disruptive effect. The present invention thus provides that an inner side of the filter bag is at least partially coated with a flocculant. For example, especially the upper region of the filter bag can be coated with the flocculant. As an alternative, it is also possible for substantially the entire inner side of the filter bag to be provided with the flocculant.

The coating with the flocculant makes it possible for smaller particles in the liquid, which are taken up in the device, to be brought together more easily and form larger flocs or particles. These larger flocs or particles sink downwards more easily and accumulate in the bottom region of the filter bag. This can enable better utilization of the filter bag and the exchange interval is advantageously extended. This can make the work with the device for providing and treating a liquid on a construction site significantly more efficient and more economical.

It is preferred in the context of the invention for the flocculant to comprise polymers and/or organic macromolecules for the solid-liquid separation of liquids. In addition, the flocculant may comprise flocculation aids which assist the flocculation of the particles and the formation of larger particles. The flocculant can preferably be composed of different substances and comprise dry, pulverulent and/or liquid constituents. For example, the pulverulent or liquid constituents of the flocculant may exhibit a cationic, anionic or non-ionic charge character. It is preferred in the context of the invention for the filter bag to be immersed in the flocculant when a liquid flocculant is used. The material of the filter bag can then become saturated with the preferably liquid flocculant, such that the flocculant can promote the separation of the drill cutting particles and/or dust particles from the liquid-drill cutting mixture. When using the saturated filter bag, the flocculant can escape from the material of the filter bag and mix with the liquid-drill cutting mixture. As a result of the work with the power tool, the liquid-drill cutting mixture in the device for providing and treating a liquid may be shaken, such that turbulence is produced in the filter bag of the water management system, which advantageously ensures thorough mixing of the liquid-drill cutting mixture with the flocculant. This can further improve the separation of the drill cutting particles and/or dust particles from the liquid-drill cutting mixture.

It goes without saying that the flocculant can also be applied and used in other ways. It is for example conceivable for the flocculant to be applied as solid flocculant to the inner side of the filter bag and to escape from the filter bag material when using the water management system, in order to mix with the liquid-drill cutting mixture. For example, the flocculant may be mixed with a water-soluble substance, such as gelatine, in order to be applied to the inner side of the filter bag. When the flocculant applied in this way comes into contact with water from the liquid-drill cutting mixture, the water-soluble substance can dissolve and thus dispense or release the flocculant into the liquid-drill cutting mixture.

It has been shown that such flocculants can be used very effectively in devices for providing and treating liquids or in their filter bags. This can in particular be attributed to the fact that the drilling liquid within the filter bag is always thoroughly mixed due to the liquid circuit maintained by the device for providing and treating a liquid. In the context of this thorough mixing, the flocculant applied as coating can also be very effectively distributed within the drilling liquid within the filter bag. In this way, the flocculant can act very quickly and effectively and ensure that smaller drill cutting particles and/or dust particles are quickly brought together and form larger particles and “flocs”. These larger and especially also heavier particles then sink by gravity quickly to the bottom, i.e. to a lower region of the filter bag where they do not block the upper, passable pores of filter bag. In this way, a filter bag can be used for considerably longer than hitherto and an undesired exchange can advantageously be delayed.

In a second aspect, the invention relates to a method for producing a filter bag for a device for providing and treating a liquid. The invention additionally relates to a filter bag and to the use of the filter bag. The terms, definitions and technical advantages introduced for the device for providing and treating a liquid preferably apply analogously to the production method, to the filter bag and to the use thereof. The production method is characterized in that an inner side of the filter bag is at least partially coated with a flocculant. The filter bag and the use thereof—in particular in a device for providing and treating a liquid—are characterized in that an inner side of the filter bag is at least partially coated with a flocculant.

In this way, smaller particles in the liquid can be brought together more easily and form larger flocs or particles. These larger flocs or particles sink downwards particularly quickly in one spatial direction and accumulate in the bottom region of the filter bag. This makes it possible to avoid clogging and blocking of the upper passable pores of the filter bag and to ensure better utilization of the filter bag. In particular, it has been shown that the exchange interval can gratifyingly be extended. This can make the work with the device for providing and treating a liquid on a construction site significantly more efficient and more economical.

Further advantages will become apparent from the following description of the figures. The figure, the description and the claims contain numerous features in combination. The person skilled in the art will also expediently consider the features individually and combine them into further expedient combinations.

### BRIEF DESCRIPTION OF THE DRAWINGS

Identical and similar components are denoted by the same reference signs in the figure,

in which:

FIG. 1 shows a view of a preferred embodiment of the device for providing and treating a liquid

### DETAILED DESCRIPTION

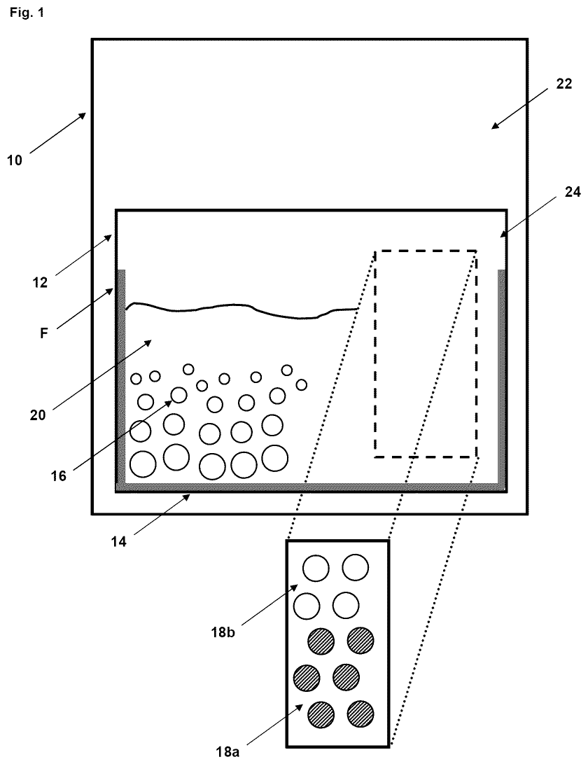

FIG. 1 shows a preferred embodiment of the device 10 for providing and treating a liquid 20. Inserted in the interior 22 of the device 10, which can preferably also be referred to as a water treatment plant or water management system (WMS) in the context of the invention, is a filter bag 12 in which liquid 20 is located. This liquid 20 may be a drilling liquid or drilling slurry, as can be produced when working with a power tool on a construction site. Drilling slurry 20 can, for example, be produced whenever the tool or the work location of a power tool has to be cooled and/or rinsed with a cooling or rinsing liquid 20, for example in the case of a core drill. In this case, drill cutting particles or dust particles 16 having very different diameters can be present in the drilling liquid 20. The drill cutting particles or dust particles 16 are indicated in FIG. 1 by the circles having different diameters, which are located at the bottom left within the filter bag 12. Even though mention is frequently made of drilling slurry and drilling liquid in the description of the invention, the invention can of course also be applied to all other mixtures of liquid with shavings, particles, dust particles and the like, independently of whether they occur during sawing, drilling, chiselling or grinding, without being restricted thereto.

The size distribution of the drill cutting particles or dust particles 16 is intended to indicate that large and heavy drill cutting particles or dust particles 16 tend to settle further down, whereas lightweight and small drill cutting particles or dust particles 16 tend to stay within the drilling liquid 20 in an upper region of the filter bag 12.

The filter bag 12 illustrated in FIG. 1 has a coating 14 on the inner side 24 thereof. The coating 14 comprises a flocculant F which induces the drill cutting particles or dust particles 16 to join together to form particles having larger diameters. The flocculant is intended to induce the drill cutting particles or dust particles 16 to flocculate and form larger and heavier drill cutting particles or dust particles 16. The inventor has identified that such larger and heavier drill cutting particles or dust particles 16 sink downwards more quickly in the filter bag 12.

The material of the filter bag 12 can have pores 18a, 18b. Such pores 18a, 18b are illustrated as circles in the enlarged detail of the filter bag 12 in FIG. 1. Without the invention, i.e. when conventional filter bags 12 are used without a coating 14 in the device 10 for providing and treating a liquid 20, all the pores 18a, 18b of the filter bag 12 can clog. Clogged pores 18a are marked by hatching in FIG. 1. The invention, i.e. the provision of a coating 14 of the filter bag 12 or the inner side 24 thereof with a flocculant F, makes it possible to effectively prevent clogging and blocking of the pores 18, especially in the upper region of the filter bag 12. This is in particular because small drill cutting particles or dust particles 16 are brought together more quickly to form large drill cutting particles or dust particles 16 and sink onto the bottom of the filter bag 12. As a result, the pores 18 of the filter bag 12, especially the pores 18b in the upper region of the filter bag 12, can remain open and passable for the drilling liquid 20, such that the device 10 for providing and treating a liquid 20 can continue to operate without a change of the filter bag 12. In this way, the time span between two filter changes of the device 10 for providing and treating a liquid 20 can be extended substantially and the work with such a device 10 can be made significantly more efficient.

### LIST OF REFERENCE SIGNS

10 Device for providing and treating a liquid
12 Filter bag
14 Coating
16 Drill cutting particles and dust particles
18a, 18b Pores in the filter beg
18a Clogged pores
18b Open, passable pores
20 Liquid or drilling liquid or drilling slurry
22 Interior space of the device
24 Inner side of the filter beg
F Flocculant

What is claimed is:

1. A device for providing and treating a liquid purifiable in an interior of the device, the device comprising:
a filter bag, the liquid purifiable in the interior of the device by the filter bag, the liquid capable of being taken up by the filter bag, an inner side of the filter bag being at least partially coated with a flocculant.

2. The device as recited in claim 1 wherein the flocculant includes polymers or organic macromolecules for the solid-liquid separation of liquids.

3. The device as recited in claim 1 wherein the flocculant includes polymers for the solid-liquid separation of liquids.

4. The device as recited in claim 1 wherein the flocculant includes organic macromolecules for the solid-liquid separation of liquids.

5. A method for producing a filter bag for the device as recited in claim 1, the method comprising:
partially coating the inner side of the filter bag with the flocculant.

6. A filter bag produced by the method according to claim 5.

7. A method of using the filter bag as recited in claim 6 to purify the liquid.
